(19) United States
(12) Patent Application Publication
(10) Pub. No.: US 2012/0061920 A1
(43) Pub. Date: Mar. 15, 2012

(54) OIL RING MECHANISM OF A PISTON

(75) Inventors: Hiroyuki Nishiura, Toyota-shi (JP); Naoya Okada, Kasugai-shi (JP); Kenji Hayama, Toyota-shi (JP); Youhei Hashimoto, Toyota-shi (JP); Hideshi Hitosugi, Saitama-City (JP); Ryosuke Naka, Hasuda-shi (JP)

(73) Assignees: NIPPON PISTON RING CO., LTD., Saitama-City (JP); TOYOTA JIDOSHA KABUSHIKI KAISHA, Toyota-shi (JP)

(21) Appl. No.: 13/321,737

(22) PCT Filed: Mar. 30, 2010
(86) PCT No.: PCT/IB10/00721

§ 371 Date: Nov. 21, 2011

(30) Foreign Application Priority Data
May 22, 2009 (JP) 2009-124700

(51) Int. Cl. F16J 9/12

(52) U.S. Cl. 277/465

(57) ABSTRACT

An oil ring mechanism of a piston includes a circumferential ring groove formed in an outer peripheral surface of the piston, and a two-piece oil ring having a ring-shaped ring main body that is arranged in the ring groove and urged in the outer peripheral direction inside the ring groove by a coil expander arranged on the inner peripheral side of the oil ring main body. On lower side surface on a crankcase side of a side wall surface of the ring groove that is on the opposite side of the ring groove from an engine combustion chamber, first and second recessed portions that reduce the abutment area where a lower surface of the ring main body abuts against the lower side surface formed in a lower side abutment surface that serves as a surface for abutting against the lower surface of the ring main body.

### BACKGROUND OF THE INVENTION

1. Field of the Invention

The invention relates to an oil ring mechanism of a piston that is formed by a ring groove formed in an outer peripheral surface of a piston used in an internal combustion engine, and an oil ring arranged in that ring groove.

2. Description of the Related Art

Two compression rings (i.e., a top ring and a second ring) are fitted to the outer periphery on the combustion chamber side (i.e., the upper side) of a piston of an internal combustion engine, and one oil ring is fitted to the outer periphery on the crankcase side (i.e., the lower side) of the piston as so-called piston rings. The compression rings serve to keep the combustion chamber airtight and inhibit exhaust gas from leaking out of the combustion chamber through a clearance between the piston and the cylinder, as well as transmit heat from the piston to the wall surface of the cylinder in order to prevent the piston temperature from rising too high. Meanwhile, the oil ring serves to scrape off excess lubricating oil that has adhered to the wall surface of the cylinder in order to form a suitable oil film on that wall surface, as well as create an oil seal between the combustion chamber side of the piston and the crankcase side of the piston. Despite this, lubricating oil still ends up leaking up into the combustion chamber via this oil ring. That is, lubricating oil that has adhered to the cylinder wall surface is drawn into the combustion chamber via these oil rings by the vacuum (negative pressure) that is created in the combustion chamber when the piston falls, as a result of control of a variable valve timing mechanism or the like on the cylinder head side. As a result, the amount of oil consumed increases, and the lubricating oil in the combustion chamber also ends up being combusted.

FIGS. 7A and 7B are sectional views of the structure of a two-piece oil ring 53 arranged with a predetermined clearance CL1 in the vertical direction of a ring groove 52 of a piston 51, as one example of such an oil ring. This two-piece oil ring 53 moves up and down as the piston 51 moves. However, when the direction of vertical movement of the piston 51 changes, the ring main body 54 of that two-piece oil ring 53 follows after a delay corresponding to the amount of the clearance CL1 because the ring main body 54 is pressed against the wall surface of a cylinder 50 by a coil expander 55. That is, as shown in FIG. 7A, when the direction of movement of the piston 51 changes from down to up, the ring main body 54 that had been pressed against the upper side surface 52a of the ring groove 52 of the piston 51 becomes pressed against the lower side surface 52b of the ring groove 52 after the piston moves up by the amount of that clearance CL1. Also, as shown in FIG. 7B, when the direction of movement of the piston 51 changes from up to down, the ring main body 54 that had been pressed against the lower side surface 52b of the ring groove 52 of the piston 51 becomes pressed against the upper side surface 52a of the ring groove 52 after the piston moves down by the amount of that clearance CL1. Therefore, when the piston 51 rises, lubricating oil on the wall surface of the cylinder 50 is scraped off by the tip end portion of the upper surface 54a of the ring main body 54 and collects between the ring main body 54 and the ring groove 52. Conversely, when the piston 51 falls, lubricating oil on the wall surface of the cylinder 50 flows to the crankcase side through the space between the lower surface 54b of the ring main body 54 and the lower side surface 52b of the ring groove 52, and the space between the upper surface 54a of the ring main body 54 and the upper side surface 52a of the ring mechanism 52 closes off, thus inhibiting lubricating oil from leaking up into the combustion chamber via the oil ring. In this way, the two-piece oil ring 53 reduces the amount of oil consumed by scraping off the lubricating oil and inhibiting the lubricating oil from leaking up into the combustion chamber via the oil ring. The amount of oil consumed is even greater it is with a so-called three-piece oil ring or the like which has side rails that sandwich the expander from above and below, for example.

That is, with this two-piece oil ring 53, it was thought that when the direction of movement of the piston 51 changes from up to down, the ring main body 54 that had been pressed against the lower side surface 52b of the ring groove 52 of the piston 51 immediately separates (i.e., moves away) from the lower side surface 52b as a result of upward inertia force generated as the piston 51 decelerates and friction force with the wall surface of the cylinder 50 or the like. In actuality, however, the lower surface 54b of the ring main body 54 does not immediately separate from the lower side surface 52b of the ring groove 52, but rather moves down for a while together with the piston 51 because of the sticking force of the lubricating oil 57. Therefore, the space between the upper surface 54a of the ring main body 54 and the upper side surface 52a of the ring groove 52 remains open while the piston 51 moves downward. As a result, lubricating oil leaks up into the combustion chamber via the oil ring as indicated by the arrow in FIG. 7B, thus increasing the amount of oil consumed.

Therefore, as is evident in Japanese Patent Application Publication No. 2002-310002 (JP-A-2002-310002), for example, a two-piece oil ring has been proposed that aims to further reduce the amount of oil consumed. This two-piece oil ring is such that the inner peripheral surface of the ring main body is a slanted surface, and a spring urges toward the ring main body via that slanted surface. That is, by arranging the ring main body in a ring groove with the slanted surface facing downward, the urging force of the spring in the outer peripheral direction is applied in the direction of the cylinder wall surface via that slanted surface, as well as in the direction of the upper side surface of the ring groove via that slanted surface. As a result, the clearance between the upper surface of the ring main body and the upper side surface of the ring groove closes, thus reducing the amount of lubricating oil that leaks up into the combustion chamber via the oil ring through that clearance.

Incidentally, although the two-piece oil ring described in JP-A-2002-310002 is able to reduce the amount of lubricating oil that leaks up into the combustion chamber via the oil ring, it also restricts the movement of the lubricating oil that has been scraped off on the combustion chamber side toward the crankcase side because it closes off the space between the upper surface of the ring main body and the upper side surface of the ring groove. Therefore, the lubricating oil that has been scraped off remains on the combustion chamber side, and it becomes difficult to reduce the consumption of that residual lubricating oil.

### SUMMARY OF THE INVENTION

The invention therefore provides a two-piece oil ring mechanism of a piston that is able to suppress the amount of oil consumed by working in conjunction with a ring groove.

Thus, one aspect of the invention relates to an oil ring mechanism of a piston that is provided with a circumferential ring groove formed in an outer peripheral surface of the piston that moves in a reciprocating motion inside a cylinder of an internal combustion engine, and a two-piece oil ring having a ring-shaped oil ring main body that is arranged in the ring groove and urged in the outer peripheral direction inside the ring groove by a coil expander arranged on the inner peripheral side of the oil ring main body. One or a plurality of recessed portions that reduce the abutment area of at least one abutment surface, from among i) an abutment surface on a crankcase side of a side wall surface of the ring groove that is on the opposite side of the ring groove from an engine combustion chamber, and ii) an abutment surface of the oil ring main body that faces that surface, are formed in the at least one abutment surface.

According to the aspect described above, the abutment area when the oil ring is abutted against the ring groove is reduced due to the recessed portions formed in the abutment surface. As a result, the sticking force generated between the side wall surface of the ring groove and the abutment surface of the oil ring main body by the lubricating oil sandwiched in between those surfaces decreases. Therefore, less sticking force is generated between the ring groove and the oil ring main body when the piston rises, so when the piston falls, the oil ring main body is able to quickly separate (i.e., move away) from the wall surface of the cylinder while the friction force between the oil ring main body and the wall surface of the cylinder and the upward inertia force of the oil ring main body that acts as a force against the sticking force are low. Accordingly, when the piston rises, lubricating oil of the wall surface of the cylinder on the combustion chamber side can be recovered. Also, when the piston falls, the oil ring quickly moves from the side wall surface that is on the opposite side of the ring groove from the engine combustion chamber to the side wall surface that is on the same side of the ring groove as the engine combustion chamber, such that the lubricating oil that collects in the ring groove when the piston rises is inhibited from moving into the engine combustion chamber. As a result, an increase in the amount of lubricating oil consumed can be suppressed.

Also, according to the aspect described above, the oil ring will separate from the ring groove even if the friction force with the wall surface of the cylinder is reduced. Therefore there will be less of an increase in the amount of oil consumed due to a decrease in the friction force between the oil ring and the cylinder wall surface, so it is possible to reduce the friction force of the oil ring on the wall surface of the cylinder in an attempt to reduce friction loss. As a result, the amount of oil that is consumed can be maintained, and fuel efficiency can be increased by reducing the friction loss of the oil ring.

In the aspect described above, the plurality of recessed portions may be arranged at equal intervals in the radius direction.

According to the aspect described above, when a plurality of the recessed portions are provided, they are arranged at equal intervals such that the distribution of sticking force of the oil ring to the ring groove is even. Accordingly, when the oil ring separates from the ring groove, the oil ring is inhibited from tilting due to uneven sticking force to the ring groove. That is, an increase in the friction force with the cylinder wall surface and deterioration of the oil seal due to the oil ring tilting can be reduced and the oil seal by the oil ring can be maintained, while friction force with the wall surface of the cylinder can be reduced.

In the aspect described above, the one or the plurality of recessed portions may be provided as circumferential grooves in at least one of the abutment surfaces.

According to the aspect described above, fanning the circumferential grooves in at least one of the abutment surfaces that are formed by the side wall surface of the ring groove and the surface of the oil ring main body by the oil ring main body abutting against the ring groove facilitates even distribution of the sticking force of the oil ring to the ring groove.

In the aspect described above, the one or the plurality of recessed portions may be provided as arc-shaped grooves in at least one of the abutment surfaces.

In the aspect described above, the one or the plurality of recessed portions may be provided in the ring groove.

According to the aspect described above, providing the recessed portion(s) in the ring groove of the piston enables an oil ring mechanism of a piston to be implemented with an oil ring and a ring groove. At this time, the oil ring mechanism may also be formed using a typical oil ring, which enables this kind of oil ring mechanism to be implemented more easily.

In the aspect described above, the one or the plurality of recessed portions provided in the ring groove may be provided in positions so as not to interfere with the inner periphery of the oil ring main body.

According to the aspect described above, the inner peripheral surface of the oil ring main body will not interfere with the recessed portion of the ring groove in a way that would cause problems, such as the inner peripheral surface of the oil ring main body catching on the recessed portion of the ring groove. Therefore, reliability of this kind of oil ring mechanism can be maintained.

In the aspect described above, the one or the plurality of recessed portions may be faulted such that an inner peripheral surface of the oil ring main body will not overlap with the one or the plurality of recessed portions due to the oil ring main body moving in the radius direction.

In the aspect described above, the one or the plurality of recessed portions may be formed in the oil ring main body.

According to the aspect described above, providing the recessed portion(s) in the oil ring main body enables the oil ring mechanism of the piston to be implemented with the oil ring and the ring groove. At this time, the oil ring mechanism may also be formed using a typical piston, which enables this kind of oil ring mechanism to be implemented more easily.

In the aspect described above, the one or the plurality of recessed portions provided in the oil ring main body may be provided in positions so as not to interfere with an outer peripheral surface of the piston.

According to the aspect described above, the outer peripheral surface of the piston will not interfere with the recessed portion of the oil ring main body in a way that would cause problems, such as the outer peripheral surface of the piston catching on the recessed portion of the oil ring main body. Therefore, reliability of this kind of oil ring mechanism can be maintained.

In the aspect described above, the one or the plurality of recessed portions may be formed such that a lower side outer peripheral surface of the piston will not overlap with the one or the plurality of recessed portions due to the oil ring main body moving in the radius direction.

In the aspect described above, the sectional shape of the one or the plurality of recessed portions may be rectangular-shaped, polyangular-shaped, or arc-shaped, or any combination of two or more of these shapes.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a sectional view of an oil ring mechanism of a piston according to a first example embodiment of the invention;

FIG. 2A is an enlarged sectional view of the oil ring mechanism according to the first example embodiment;

FIG. 2B is a sectional view of a section taken along line 2b-2b of FIG. 2A;

FIG. 3 is a graph of the oil consumption rate of an internal combustion engine;

FIG. 4A is a sectional view of an oil ring mechanism of a piston according to a second example embodiment of the invention;

FIG. 4B is a sectional view of a section taken along line 4b-4b of FIG. 4A;

FIG. 5A is a sectional view of a ring groove or an oil ring main body according to another example embodiment, employed in the oil ring mechanism of the piston according to the example embodiments of the invention;

FIG. 5B is a sectional view of a ring groove or a oil ring main body according to still another example embodiment, employed in the oil ring mechanism of the piston according to the example embodiments of the invention;

FIG. 6A is a plan sectional view of a ring groove according to yet another example embodiment of the oil ring mechanism of the piston according to the example embodiments of the invention;

FIG. 6B is a plan sectional view of a ring groove according to still another example embodiment of the oil ring mechanism of the piston according to the example embodiments of the invention;

FIG. 7A is a sectional view illustrating the operation of a typical oil ring of a piston when the movement of the piston changes from down to up; and

FIG. 7B is a sectional view illustrating the operation of the typical oil ring of the piston when the movement of the piston changes from up to down.

### DETAILED DESCRIPTION OF EMBODIMENTS

### First Example Embodiment

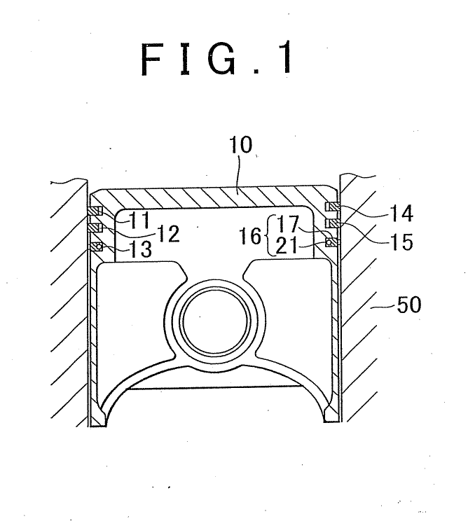

A first example embodiment of the oil ring mechanism of a piston of the invention will be described in greater detail below with reference to the accompanying drawings. FIG. 1 is a sectional view of the structure of the oil ring mechanism of a piston of this example embodiment in the vertical direction of the piston.

As shown in FIG. 1, a cylinder 50 is formed in a cylindrical shape extending in generally the vertical direction (i.e., in the vertical direction in FIG. 1). A piston 10 is structured to reciprocally move up and down in this cylinder 50. The piston 10 is formed in a generally round columnar shape that has a skirt portion on the lower side. The upper surface of the piston 10, together with the cylinder 50, defines a combustion chamber. Also, the piston 10 has first to third ring grooves 11 to 13 that have rectangular cross sections in the vertical direction formed on the upper side of its outer peripheral surface. Incidentally, an oil drain hole, not shown, is formed in the third ring groove 13. A ring groove side opening at one end portion of the oil drain hole opens to the third ring groove 13, and a piston inner peripheral surface side opening at the other end portion of the oil drain hole opens to the inside wall of the piston 10.

A first compression ring 14 is fitted into the first ring groove 11 and a second compression ring 15 is fitted into the second ring groove 12. These first and second compression rings 14 and 15 are both formed in an annular shape with a joint in one location in the circumferential direction. The outer peripheral surfaces of these first and second compression rings 14 and 15 slide against the wall surface of the cylinder 50. Thus, the first and second compression rings 14 and 15 serve to keep the combustion chamber airtight and inhibit combustion gas from leaking out of the combustion chamber through the clearance between the piston 10 and the cylinder 50, as well as to transmit heat from the piston to the wall surface of the cylinder in order to prevent the piston temperature from rising too high.

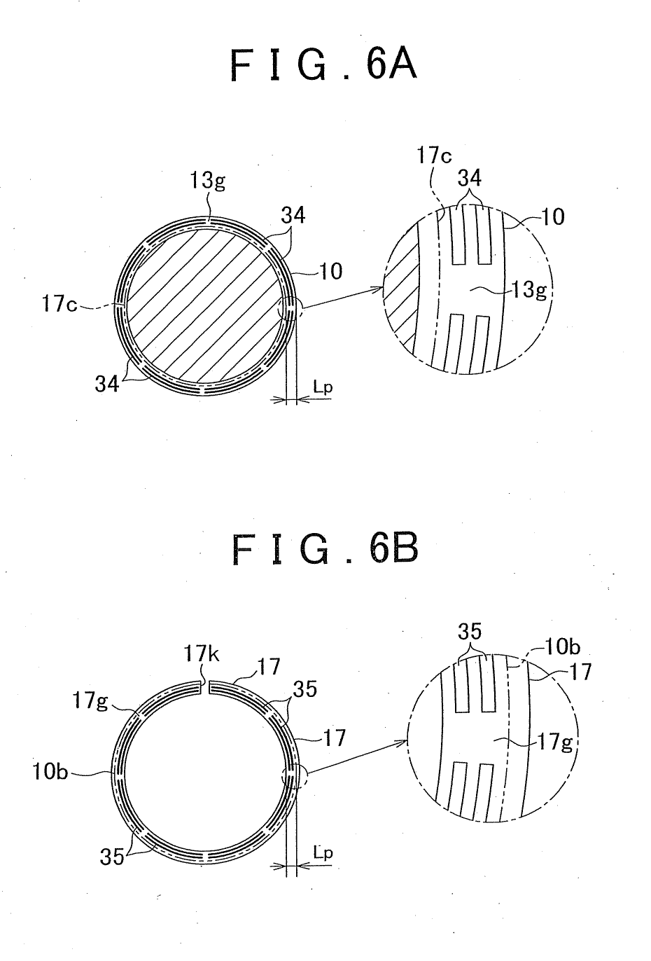

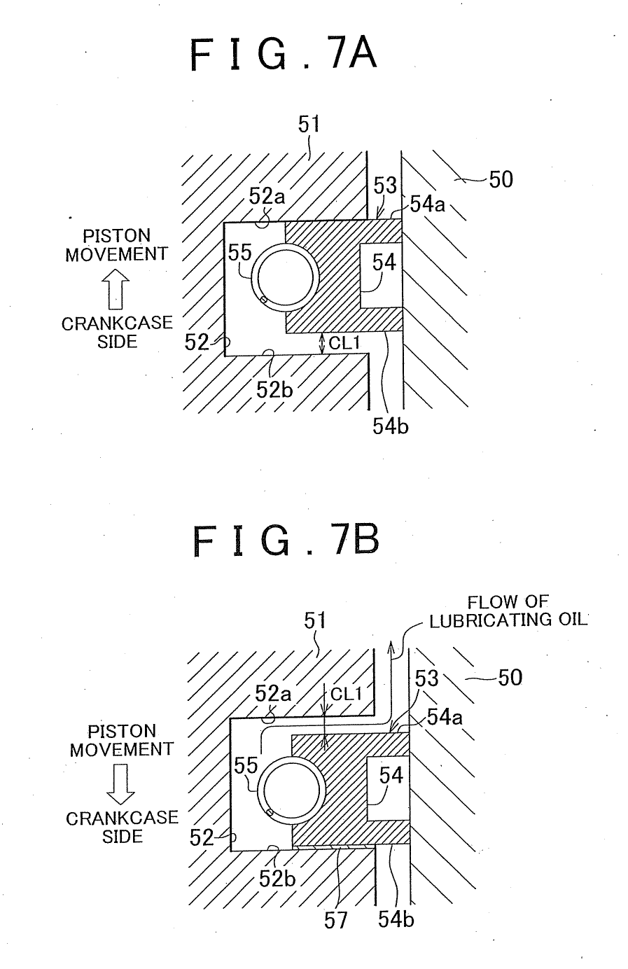

An oil ring 16 which is a two-piece piston ring is fitted into the third ring groove 13 which is the lowest of the three ring grooves 11 to 13. This oil ring 16 has an annular ring main body 17 that has a joint (17k (see FIG. 6B)) in one location in the circumferential direction, and a coil expander 21 that is arranged to the inside of the ring main body 17 and generates urging force in the outer peripheral direction by being formed from a wire rod that is wound in a coil shape and then connected in a ring shape. The outer peripheral surface of the ring main body 17 is made to abut with a predetermined urging force against the wall surface of the cylinder 50 by being urged in the outer peripheral direction by the coil expander 21. Accordingly, the oil ring 16 serves to both scrape off excess lubricating oil that has adhered to the wall surface of the cylinder in order to form a suitable oil film on that wall surface, and maintain an oil seal between the combustion chamber side of the piston 10 and the crankcase side of the piston 10. These functions of the oil ring 16 make it possible to suppress lubricating oil from leaking up into the combustion chamber via the oil ring. That is, it is possible to suppress lubricating oil that has adhered to the wall surface of the cylinder 50 from being drawn into the combustion chamber via this oil ring 16 by the vacuum (negative pressure) that is created in the combustion chamber when the piston 10 falls. In turn, combustion of the lubricating oil in the combustion chamber that increases the amount of oil consumed is suppressed. Incidentally, in this example embodiment, the oil ring mechanism is formed from the third ring groove 13 and the oil ring 16.

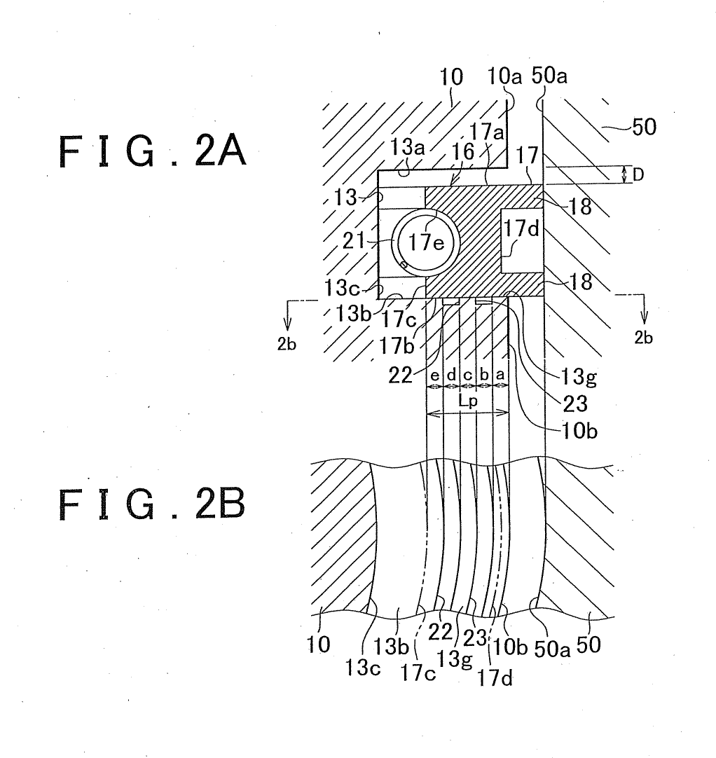

Next, the oil ring mechanism will be described in detail with reference to FIGS. 2A and 2B. FIG. 2A is a vertical sectional view of the structure of the oil ring 16 and the area around the oil ring 16. FIG. 2B is a sectional view of a section taken along line 2b-2b in FIG. 2A.

As shown in FIG. 2A, the ring main body 17 of the oil ring 16 has an upper surface 17a and a lower surface 17b that are at right angles (horizontal in FIG. 2A) to the center axis of the piston 10. Also, a first groove 17d that has a rectangular cross-section is formed in the center in the outer peripheral surface of the ring main body 17 that faces the wall surface of the cylinder 50. As a result, a protrusion 18 that continues on from the upper surface 17a is formed on the upper side of the first groove 17d and another protrusion 18 that continues on from the lower surface 17b is formed on the lower side of the first groove 17d. Furthermore, a second groove 17e that has an arc-shaped cross-section is formed in the center in the direction of thickness of the inner peripheral surface 17c of the ring main body 17.

The coil expander 21 is fitted into the second groove 17e and urges the second groove 173 in the outer peripheral direction. That is, the diameter of the coil expander 21 is substantially the same as the width (i.e., the length in the vertical direction in FIG. 2A) of the opening of the second groove 17e, and the coil expander 21 is arranged such that generally half of the arc-shaped cross-section on the outer peripheral side is fitted into the second groove 17e.

The third ring groove 13 divides the outer peripheral surface of the piston 10 into an upper side outer peripheral surface 10a and a lower side outer peripheral surface 10b. Also, the upper side of the side wall surface formed in the piston 10 is referred to as an upper side surface 13a, the lower side of the side wall surface formed in the piston 10 is referred to as a lower side surface 13b, and the bottom surface in the axial direction is referred to as an inside surface 13c. The width in the axial direction of the opening of the third ring groove 13 is wider than the thickness of the ring main body 17 by a clearance distance D, so the ring main body 17 is able to move vertically by that clearance distance D when fit in the third ring groove 13. As a result, the upper surface 17a and the lower surface 17b of the ring main body 17 will abut against the upper side surface 13a and the lower side surface 13b, respectively, of the ring groove 13 when the piston 10 moves up and down. An upper side abutment surface that abuts against the upper surface 17a is formed on the upper side surface 13a of the ring groove 13, and a lower side abutment surface 13g that abuts against the lower surface 17b is formed on the lower side surface 13b of the ring groove 13. The lower side abutment surface 13g is formed in a ring shape on the lower side surface 13b of the ring groove 13, with the inner periphery of this lower side abutment surface 13g in a position corresponding to an inner peripheral surface 17c of the ring main body 17, and the outer periphery of the lower side abutment surface 13g in a position corresponding to the lower side outer peripheral surface 10b of the piston 10. Between that inner periphery and outer periphery is an abutment width Lp which is the width of the ring shape.

A first recessed portion 22 and a second recessed portion 23 are formed in the lower side abutment surface 13g of the third ring groove 13. Also, the first and second recessed portions 22 and 23 are recessed portions with rectangular cross-sections having openings on the lower side abutment surface 13g. These first and second recessed portions 22 and 23 are arranged in preset positions in the horizontal direction of the piston 10 in the lower side abutment surface 13g. Therefore, the abutment area of the lower side abutment surface 13g that abuts against the lower surface 17b of the ring main body 17 is decreased by the amount of the openings of the first and second recessed portions 22 and 23. Also, in this example embodiment, the abutment width Lp of the lower side abutment surface 13g is divided equally into five sections, i.e., section a, section b, section c, section d, and section e, in that order from the lower side outer peripheral surface 10b. The second recessed portion 23 is provided in section b and the first recessed portion 22 is provided in section d. Accordingly, the first recessed portion 22 and the second recessed portion 23 are arranged at equal intervals in the width direction of the lower side abutment surface 13g, such that the abutment area of the lower side surface 13b of the third ring groove 13 that abuts against the lower surface 17b of the ring main body 17 is distributed evenly in the peripheral direction of the lower side abutment surface 13g.

Also, the position where the oil ring 16 is arranged may shift in the radius direction with respect to the ring groove 13 due to a change in the clearance between the piston 10 and the cylinder 50. Therefore, by increasing the width of section e so that it is wider than the distance that the ring main body 17 moves in the radius direction, it is possible to prevent the lower portion of the inner peripheral surface 17c of the ring main body 17 from interfering with and catching on or fitting into (i.e., engaging with) the first recessed portion 22, even if the ring main body 17 moves in the horizontal direction in the ring groove 13.

Next, the operation of the oil ring mechanism as the piston 10 moves up and down will be described. The oil ring 16 of the oil ring mechanism moves up and down as the piston 10 moves. However, the ring main body 17 of that oil ring 16 is pressed against the wall surface of the cylinder 50 by the coil expander 21, so when the vertical direction in which the piston 10 is moving changes, in principle, the vertical direction in which the ring main body 17 changes after a delay corresponding to the clearance distance D. That is, when the direction in which the piston 10 moves changes from down to up, the ring main body 17 that had been pressed against the upper side surface 13a of the ring groove 13 of the piston 10 becomes pressed against the lower side surface 13b of the ring groove 13 after the piston 10 moves upward by an amount corresponding to the clearance distance D. Conversely, when the direction in which the piston 10 moves changes from up to down, the ring main body 17 that had been pressed against the lower side surface 13b of the ring groove 13 of the piston 10 becomes pressed against the upper side surface 13a of the ring groove 13 after the piston 10 moves downward by an amount corresponding to the clearance distance D.

Incidentally, when the direction in which the piston 10 moves changes from up to down, force in a direction away from the lower side surface 13b immediately acts on the ring main body 17 that had been pressed against the lower side surface 13b of the ring groove 13 of the, piston 10, due to the upward inertia force generated as the piston 10 slows and friction force with the wall surface 50a of the cylinder 50 and the like. On the other hand, the sticking force of lubricating oil, not shown, with the lower side abutment surface 13g of the lower side surface 13b of the ring groove 13 acts on the lower surface 17b of the ring main body 17. Therefore, the ring main body 17 remains stuck to the ring groove 13 until the force in the direction away from the lower side surface 13b overcomes the sticking force of the lubricating oil.

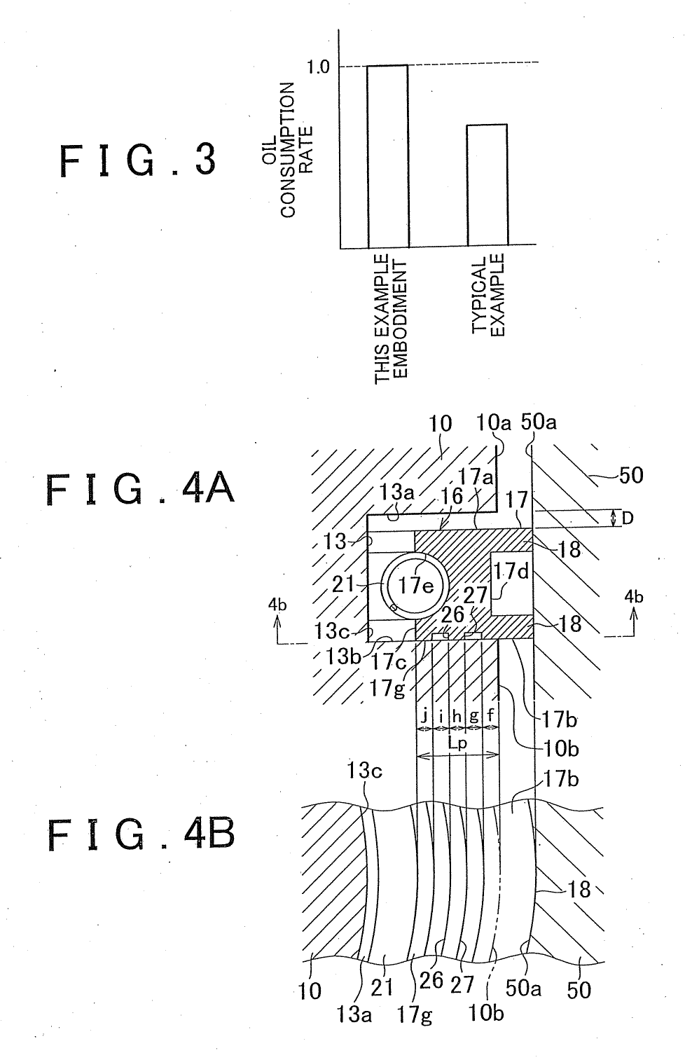

However, in this example embodiment, the first and second recessed portions 22 and 23 formed in the lower side abutment surface 13g reduce the abutment area where the lower side abutment surface 13g abuts against the lower surface 17b of the ring main body 17, which reduces the sticking force generated between these surfaces. Also, even if the lubricating oil collected in the first and second recessed portions 22 and 23 contacts the lower surface 17b, the degree of freedom of movement and deformation of that lubricating oil is higher than it is with lubricating oil arranged thinly between the lower side abutment surface 13g and the lower surface 17b. Thus, the sticking force generated by the lubricating oil collected in the first and second recessed portions 22 and 23 also decreases, so the overall sticking force generated at the lower side abutment surface 13g decreases. As a result, when force in the direction away from the lower side surface 13b acts on the ring main body 17 as it does with a typical oil ring, the sticking force from the lubricating oil between the lower side abutment surface 13g and the lower surface 17b decreases. Therefore, when the direction in which the piston 10 moves changes from up to down, the oil ring 16 separates (i.e., moves away) from the lower side surface 13b of the ring groove 13 faster than a typical oil ring does. As a result, the time that the piston 10 moves downward while the space between the upper surface 17a of the ring main body 17 and the upper side surface 13a of the ring groove 13 is open becomes shorter, thus suppressing this lubricating oil from leaking up into the combustion chamber via the oil ring 16, so the amount of oil consumed can be reduced. FIG. 3 is a graph comparing the oil consumption rate of a typical internal combustion engine with the oil consumption rate in this example embodiment. As shown in FIG. 3, for example, the coil consumption rate according to this example embodiment is approximately 30 to 40 percent lower than the typical oil consumption rate.

Incidentally, various proposals for inhibiting a compression ring from adhering to the ring groove as a result of high temperature and high pressure are known. One such proposal involves forming a groove for retaining lubricating oil that produces a cooling effect on a surface that abuts against the ring groove in order to inhibit that abutment surface from adhering to the ring groove. However, the principle behind why the kind of oil ring described above sticks to the ring groove is different from the principle behind why the compression ring adheres to the ring groove, so the problems to be solved also differ. Therefore, there is no reason to employ a structure that inhibits adhesion that is used with a compression ring to an oil ring.

As described above, the oil ring mechanism of a piston of this example embodiment enables the effects listed below to be obtained.

(i) The abutment area when the oil ring 16 is abutted against the ring groove 13 is reduced due to the recessed portions 22 and 23 Mulled in the lower side abutment surface 13g. As a result, the sticking force generated between the abutment surfaces where the lower surface 17b of the ring main body 17 abuts against the lower side surface 13b of the ring groove 13 by the lubricating oil sandwiched in between those surfaces decreases. Therefore, less sticking force is generated between the ring groove 13 and the ring main body 17 when the piston 10 rises, so when the piston 10 falls, the ring main body 17 is able to quickly separate from the wall surface 50a of the cylinder 50 while the friction force between the ring main body 17 and the wall surface 50a of the cylinder 50 is low. Accordingly, when the piston 10 rises, lubricating oil of the wall surface 50a of the cylinder 50 on the combustion chamber side can be recovered. Also, when the piston 10 falls, the oil ring 16 quickly moves from the lower side surface 13b that is on the opposite side of the ring groove 13 from the engine combustion chamber to the upper side surface 13a that is on the same side of the ring groove 13 as the engine combustion chamber, such that the lubricating oil that collects in the ring groove 13 when the piston 10 rises is inhibited from moving into the engine combustion chamber. As a result, an increase in the amount of lubricating oil consumed can be suppressed.

(ii) Also, with this kind of structure, the oil ring 16 will separate from the ring groove 13 even if the friction force with the wall surface 50a of the cylinder 50 is reduced. Therefore there will be less of an increase in the amount of oil consumed due to a decrease in the friction force between the oil ring 16 and the wall surface 50a of the cylinder 50, so it is possible to reduce the friction force of the oil ring 16 on the wall surface 50a of the cylinder 50 in an attempt to reduce friction loss. As a result, the amount of oil that is consumed can be maintained, and fuel efficiency can be increased by reducing the friction loss of the oil ring 16.

(iii) The plurality of recessed portions 22 and 23 are arranged at equal intervals such that the sticking force of the oil ring 16 to the ring groove 13 is distributed evenly. Accordingly, when the oil ring 16 separates from the ring groove 13, the oil ring 16 is inhibited from tilting due to uneven sticking force to the ring groove 13. That is, an increase in the friction force with the cylinder wall surface and deterioration of the oil seal due to the oil ring 16 tilting can be reduced and the oil seal by the oil ring 16 can be maintained, while friction force with the wall surface 50a of the cylinder 50 can be reduced.

(iv) Recessed portions are formed as circumferential grooves in the lower side abutment surface 13g that is formed on the lower side surface 13b of the ring groove 13 by the ring main body 17 abutting against the ring groove 13. This facilitates even distribution of the sticking force of the oil ring 16 to the ring groove 13.

(v) The oil ring mechanism is fox by providing the recessed portions 22 and 23 in the ring groove 13 of the piston 10. At this time, the oil ring mechanism can also be formed using a typical oil ring, which enables this kind of oil ring mechanism to be implemented more easily.

(vi) Providing section e of a predetermined width prevents the inner peripheral surface 17c of the ring main body 17 from interfering with the first recessed portion 22 of the ring groove 13 in a way that would cause problems, such as the inner peripheral surface 17c of the ring main body 17 catching on the first recessed portion 22 of the ring groove 13. Therefore, reliability of this kind of oil ring mechanism can be maintained.

### Second Example Embodiment

Next, a second example embodiment of the piston ring mechanism of a piston according to the invention will be described with reference to FIGS. 4A and 4B. FIG. 4A is an enlarged sectional view of a vertical section the oil ring 16 and a portion corresponding to the area around the oil ring 16, and FIG. 4B is a sectional view of a section taken along line 4b-4b in FIG. 4A.

This second example embodiment differs from the first example embodiment in that the recessed portions, which are provided in the ring groove 13 in the first example embodiment, and are provided in the lower surface 17b of the ring main body 17 in this second example embodiment. The other structure is the same, so for convenience, portions in this second example embodiment that are the same as portions in the first example embodiment will be denoted with the same reference characters and descriptions of those portions will be omitted.

As shown in FIGS. 4A and 4B, with this example embodiment as well, the ring main body 17 is arranged in the third ring groove 13 such that there is a clearance of a clearance distance D in the vertical direction. Thus, when the piston 10 moves down, the upper surface 17a of the ring main body 17 abuts against the upper side surface 13a of the ring groove 13, and when the piston 10 moves up, the lower surface 17b of the ring main body 17 abuts against the lower side surface 13b of the ring groove 13. Accordingly, an upper side abutment surface is formed at the portion where the upper surface 17a abuts against the upper side surface 13a, and a lower side abutment surface 17g is formed at the portion where the lower surface 17b abuts against the lower side surface 13b. At this time, the lower side abutment surface 17g is formed in a ring shape on the lower surface 17b of the ring main body 17, with the inner periphery of this lower side abutment surface 17g in a position corresponding to the inner peripheral surface 17c of the ring main body 17, and the outer periphery of the lower side abutment surface 17g in a position corresponding to the lower side outer peripheral surface 10b of the piston 10. Between that inner periphery and outer periphery is the abutment width Lp which is the width of the ring shape.

A first recessed portion 26 and a second recessed portion 27 are formed in the lower side abutment surface 17g of the ring main body 17. Also, the first and second recessed portions 26 and 27 are recessed portions with rectangular cross-sections having openings on the lower side abutment surface 17g. These first and second recessed portions 26 and 27 are arranged in preset positions in the lower side abutment surface 17g in the horizontal direction of the piston 10. More specifically, in this example embodiment, the abutment width Lp of the lower side abutment surface 17g is divided equally into five sections, i.e., section f, section g, section h, section i, and section j, in that order from the location corresponding to the lower side outer peripheral surface 10b. The second recessed portion 27 is provided in section g and the first recessed portion 26 is provided in section i. Accordingly, the first recessed portion 26 and the second recessed portion 27 are arranged at equal intervals in the width direction of the lower side abutment surface 17g, such that the abutment area where the lower side abutment surface 13b of the third ring groove 13 abuts against the lower surface 17b of the ring main body 17 is distributed evenly in the peripheral direction of the lower side abutment surface 17g.

Also, the arrangement of the oil ring 16 may shift in the radius direction with respect to the ring groove 13 due to a change in the clearance between the piston 10 and the cylinder 50. Therefore, by increasing the width of section f so that it is wider than the distance that the ring main body 17 moves in the radius direction, it is possible to prevent the second recessed portion 27 of the ring main body 17 from interfering with and catching on or fitting into (i.e., engaging with) the lower side outer peripheral surface 10b of the piston 10.

Next, the operation of the oil ring mechanism as the piston 10 moves up and down will be described. Sticking force acts on the ring main body 17, just as in the first example embodiment. However, the first and second recessed portions 26 and 27 formed in the lower side abutment surface 17g reduce that sticking force by decreasing the abutment area where the lower side abutment surface 17g abuts against the lower side surface 13b of the ring groove 13. Also, the lubricating oil collected in the first and second recessed portions 26 and 27 has a higher degree of freedom of movement and deformation than the lubricating oil arranged thinly between the lower side abutment surface 17g and the lower surface 13b does. Thus, the sticking force generated by the lubricating oil collected in the first and second recessed portions 26 and 27 also decreases, so the overall sticking force generated at the lower side abutment surface 17g decreases. As a result, when force in the direction away from the lower side surface 13b acts on the ring main body 17 as it does with a typical oil ring, the sticking force from the lubricating oil between the lower side abutment surface 17g and the lower side surface 13b decreases. Therefore, when the direction in which the piston 10 moves changes from up to down, the oil ring 16 separates from the lower side surface 13b of the ring groove 13 faster than a typical oil ring does. As a result, the time that the piston 10 moves downward while the space between the upper surface 17a of the ring main body 17 and the upper side surface 13a of the ring groove 13 is open becomes shorter, thus suppressing this lubricating oil from leaking up into the combustion chamber via the oil ring 16, so the amount of oil consumed can be reduced.

As described above, this example embodiment enables effects equivalent or similar to those described in (i) to (iii) of the first example embodiment to be obtained, as well as enables the effects described below to be obtained.

(vii) Recessed portions are formed as circumferential grooves in the lower side abutment surface 17g formed in the lower surface 17b of the ring main body 17 by the ring main body 17 abutting against the ring groove 13. Therefore, the sticking force of the oil ring 16 to the ring groove 13 is easily able to be evenly distributed.

(viii) The oil ring mechanism is formed by providing the recessed portions 26 and 27 in the piston main body 17. At this time, the oil ring mechanism can also be formed using a typical piston, which enables this kind of oil ring mechanism to be implemented more easily.

(ix) Providing section f of a predetermined width prevents the second recessed portion 27 of the ring main body 17 from interfering with the lower side outer peripheral surface 10b of the piston 10 in a way that would cause problems, such as the second recessed portion 27 of the ring main body 17 catching on the lower side outer peripheral surface 10b of the piston 10. Therefore, reliability of this kind of oil ring mechanism can be maintained.

Incidentally, each of the example embodiments described above may also be carried out in the modes described below, for example.

In the first example embodiment described above, section e of the lower side surface 13b of the ring groove 13 is provided in a position in which the inner peripheral surface 17c of the ring main body 17 will not interfere with the first recessed portion 22 even if the oil ring 16 moves in the horizontal direction. However, the invention is not limited to this. For example, as long as the sticking force is distributed evenly and there is no interference that is problematic, the recessed portion may also be provided in a location in which it would interfere with the inner peripheral surface of the ring main body. Therefore, the degree of freedom in implementing the oil ring mechanism can be increased.

In the example embodiments described above, the intervals of sections a to e are equal and the intervals of sections f to j are equal. However, the invention is not limited to this. For example, only some the intervals of the sections may be equal or all the intervals of the sections may be different. Therefore, the degree of freedom in arranging the recessed portions can be increased.

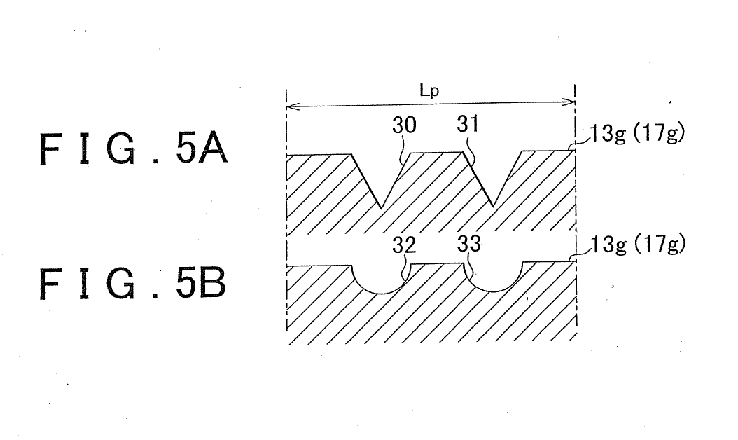

With the example embodiment described above, the recessed portions 22, 23, 26 and 27 all have rectangular cross-sections. However, the invention is not limited to this. That is, as long as the sectional shapes of the recessed portions reduce the abutment area of the abutment surfaces, they may be polyangular-shaped, arc-shaped, or a combination of these shapes. FIG. 5A is a view showing the recessed portions with triangular cross-sections, and FIG. 5B is a view showing the recessed portions with arc-shaped cross-sections. For example, triangular recessed portions 30 and 31, such as shown in FIG. 5A, may be provided in the lower side abutment surface 13g of the ring groove or the lower side abutment surface 17g of the ring main body, or arc-shaped recessed portions 32 and 33, such as those shown in FIG. 5B, may be provided in the lower side abutment surface 13g of the ring groove or the lower side abutment surface 17g of the ring main body. Therefore, the degree of freedom in the design of the recessed portions &wined in the ring groove or the ring main body can be increased.

In the example embodiments described above, the recessed portions 22 and 23 are formed circumferentially in (i.e., around the entire circumference of) the lower side abutment surface 13g and the recessed portions 26 and 27 are formed circumferentially in the lower side abutment surface 17g. However, the invention is not limited to this. That is, the recessed portions may also be formed in arc-shaped sections. For example, the recessed portions formed in the oil ring do not have to be formed at the joint portion of the oil ring. FIG. 6A is a view of a plurality of arc-shaped recessed portions 34 formed in the ring groove 13, and FIG. 6B is a view of a plurality of arc-shaped recessed portions 35 formed in the ring main body 17. As shown in FIG. 6A, circumferential recessed portions may also be formed by arranging a plurality (eight are shown in the drawing) of the recessed portions 34 that extend in the circumferential direction within the abutment width Lp of the lower side abutment surface 13g of the ring groove 13. Similarly, as shown in FIG. 6B, circumferential recessed portions may also be formed by arranging a plurality (eight are shown in the drawing) of the recessed portions 35 that extend in the circumferential direction within the abutment width Lp of the lower side abutment surface 17g of the ring main body 17. This increases the degree of freedom of the shapes of the recessed portions, which in turn increases the feasibility and applicability of the oil ring mechanism.

In the example embodiments described above, one example is described in which two recessed portions, i.e., the first and second recessed portions 22 and 23, are provided in the lower side abutment surface 13g, and one example is described in which two recessed portions, i.e., the first and second recessed portions 26 and 27, are provided in the lower side abutment surface 17g. However, the invention is not limited to these. That is, as long as a recessed portion that evenly reduces the abutment area where the lower surface of the ring main body abuts against the lower side surface of the ring groove is provided in a lower side abutment surface, the number of recessed portions may also be one or three or more. This increases the degree of freedom of the shapes of the recessed portions, which in turn increases the feasibility of the piston ring mechanism.

In the example embodiments described above, one case is described in which the recessed portions are provided in the lower side surface 13b of the ring groove 13, and another case is described in which the recessed portions are provided in the lower surface 17b of the ring main body 17. However, the invention is not limited to this. That is, the recessed portions may also be formed in both the lower surface of the ring groove and the lower side surface of the ring main body. This enables the adjustability of the sticking force by the recessed portions to be increased, which makes it possible to form an oil ring mechanism with reduced sticking force.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. An oil ring mechanism assembly comprising:
a piston that is provided with a circumferential ring groove formed in an outer peripheral surface of the piston that moves in a reciprocating motion inside a cylinder of an internal combustion engine, and
a two-piece oil ring having a ring-shaped oil ring main body that is arranged in the ring groove and urged in the outer peripheral direction inside the ring groove by a coil expander arranged on the inner peripheral side of the oil ring main body,
wherein a plurality of recessed portions that reduce the abutment area of at least one abutment surface, from among i) an abutment surface on a crankcase side of a side wall surface of the ring groove that is on the opposite side of the ring groove from an engine combustion chamber, and ii) an abutment surface of the oil ring main body that faces that surface, are formed in the at least one abutment surface,
wherein the plurality of recessed portions and a non-recessed section therebetween are arranged in parallel to the circumference and at equal intervals in the radius direction, and
wherein the plurality of recessed portions are provided as circumferential grooves or arc-shaped grooves.

2.-4. (canceled)

5. The oil ring mechanism assembly according to claim 1, wherein one or the plurality of recessed portions are provided in the ring groove.

6. The oil ring mechanism assembly according to claim 5, wherein the one or the plurality of recessed portions provided in the ring groove are provided in positions so as not to interfere with the inner periphery of the oil ring main body.

7. The oil ring mechanism assembly according to claim 6, wherein the one or the plurality of recessed portions are formed such that an inner peripheral surface of the oil ring main body will not overlap with the one or the plurality of recessed portions due to the oil ring main body moving in the radius direction.

8. The oil ring mechanism assembly according to claim 1, wherein the one or the plurality of recessed portions are formed in the oil ring main body.

9. The oil ring mechanism assembly according to claim 8, wherein the one or the plurality of recessed portions provided in the oil ring main body are provided in positions so as not to interfere with an outer peripheral surface of the piston.

10. The oil ring mechanism assembly according to claim 9, wherein the one or the plurality of recessed portions are formed such that a lower side outer peripheral surface of the piston will not overlap with the one or the plurality of recessed portions due to the oil ring main body moving in the radius direction.

11. The oil ring mechanism assembly according to claim 1, wherein the sectional shape of the one or the plurality of recessed portions is rectangular-shaped, polyangular-shaped, or arc-shaped, or any combination of two or more of these shapes.
